(19) United States
(12) Patent Application Publication
(10) Pub. No.: US 2021/0120796 A1
(43) Pub. Date: Apr. 29, 2021

(54) FISH FINDING DEVICE MOUNT

(71) Applicant: Michael Hodges, Cedar Key, FL (US)

(72) Inventor: Michael Hodges, Cedar Key, FL (US)

(21) Appl. No.: 17/082,304

(22) Filed: Oct. 28, 2020

Related U.S. Application Data
(60) Provisional application No. 62/926,880, filed on Oct. 28, 2019.

(51) Int. Cl. A01K 97/00; B63B 17/00

(52) U.S. Cl. CPC A01K 97/00; B63B 17/00

(57) ABSTRACT

A fish finding device mount is provided to be used in connection with a fish finding device that includes an electronic device communicable with a receiver. The fish finding device mount may include a mounting arm that is attachable to the transom of a boat. Attached to the mounting arm is at least one bracket that is utilized to secure an extendable arm to the mounting arm. The extendable arm includes a mounting adapter that couples the fish finder's electronic device to the mounting device. The fish finding device mount is designed to selectively submerge the fish finder's electronic device a distance below the boat's hull to prevent any form of interference, and retract the electronic device a distance out of the water to avoid an accidental collision with a foreign object during transit.

### CROSS REFERENCE TO RELATED APPLICATION

This application claims the benefit of U.S. Provisional Application No. 62/926,880 filed Oct. 28, 2019 and entitled, A Fish Finding Device Mount.

### FIELD OF THE INVENTION

The present invention relates generally to a device mount, and more particularly, to an extendable and retractable fish finding device mount device that can be attached to a boat, the fish finding device mount is designed to submerge an electronic device to a desirable depth that prevents the boat's hull from interfering with the function of the electronic device.

### BACKGROUND OF THE INVENTION

Fishing is one of America's favorite leisure pastimes. The sport fosters bonding opportunities between family and friends, and in many cases forges along lasting connection with nature and can promote a healthy physical and mental well-being. Fishing is a sport that more than 47 million people in the U.S. enjoy with more people joining in on the fun every year.

Fishing, or the method of catching fish, includes many different techniques such as hand-gathering, spearfishing, netting, angling, and trapping to name a few. The type of tool and or equipment needed to fish generally depends on the preferred technique the angler or fisherman decides to fish with. For instance, spearfishing is an ancient method of fishing conducted with a tool, such as an ordinary spear or a specialized variant like a harpoon, trident or arrow. Some fishing spears use slings, or rubber loops, to propel the spear underwater. Another form of technique that requires a tool is line fishing. Line fishing is fishing with a fishing line, which can constitute any cord made for fishing. Although there are many variations of line fishing, generally, line fishing comprises a long fishing line that includes a weight and a hook at an end being dropped vertically down into a body of water with a float attached to the opposite side (i.e., top) of the line.

Some fishing techniques, however, require both tools and equipment. For instance, boat angling, commonly known as fishing on a boat with a fishing rod, is a type of fishing that requires equipment in additional to fishing tools. This is especially true if the angler expects a positive outcome when fishing in open water, such as the ocean. One common piece of equipment used when fishing on a boat is a fish finding device (i.e., a fishfinder). A fishfinder is an instrument that's used to locate fish underwater by detecting reflected pulses of sound energy, as in sonar.

Modern fishfinder's include display devices that graphically illustrate the measurements of the reflected sounds, thereby allowing the operator, angler or fisherman to interpret information being provided to locate schools of fish, underwater debris, and the depth of the ocean floor. Installing a fishfinder to a boat generally includes attaching a transducer with a mounting arm to the stern of the boat. The mounting of the transducer on the stern is typically done on the hull of the boat, with no strakes, through hull fittings, or other items interrupting the smooth hull in front of it. That is important because anything that disturbs water flow will create turbulence, which degrades the fishfinder's performance. The transducer's power leads are fed to the fishfinder's display device. Once the fishfinder is properly installed, the fisherman or boat operator may cruise at slow speeds of about 3 to 4 knots to look for schools of fish.

A constant drawback of the preexisting mounting methods and devices used with fishfinder's is that they only work at low speeds. Traveling any faster than the recommended 3 to 4 knots causes a whiteout effect that renders the fishfinder ineffective and unable to accurately detect fish, the ocean floor, and potential debris. The whiteout effect typically occurs because of the boat's wake and hull interfering with the transducer. As a result, fisherman and or boat operators have to traverse the ocean very slowly to be able to use the fishfinder to find fish, which makes it exceedingly difficult to cover large areas of water while searching. Often, what ends up occurring when the fisherman cannot find a schools of fish around the area being fished, fishermen elect to move to different locations without the use of the fishfinder. Ultimately, having to guess where they might find a good fishing spot. This type of searching is ineffective and proven to be extremely frustrating for fishermen and boat operators all around.

Accordingly, there is an established need for an extendable and retractable, yet sturdy mounting device that can be coupled to a boat and to a fish finding electronic device. Said mounting device would be capable of selectively submerging the electronic device deep into a body of water enabling the electronic device to function without interference that would have otherwise been produced by the boat's hull and the boat's wake while the boat is cruising at a fast rate of speed.

### SUMMARY OF THE INVENTION

The present invention is directed to a fish finding device mount that is attachable to the stern of a boat. The device mount is configured to receive an electronic device, such as a transducer and is designed to be extendable and retractable, yet sturdy enough to be selectively submerged deep into a body of water while the boat is moving at a high rate of speed.

Introducing a first embodiment of the invention, the present invention comprises, a
mounting arm;
at least one bracket affixed to said mounting arm;
an extendable arm securable to said at least one bracket; and
a mounting adapter securable to said extendable arm.

In a second aspect, the mounting arm includes a second bracket.

In another aspect, the first bracket and the second bracket may not be identical.

In another aspect, the first bracket may include a u-shaped configuration.

In another aspect, the secondary bracket may include a through hole.

In another aspect, the mounting arm may include a body of an unbendable thickness that includes an exterior surface and an interior surface.

In another aspect, the mounting arm may include a top portion and a bottom portion to form a unitary body.

In another aspect, the top portion of the mounting arm may be provided in the form of a bent arm that include a continuous first end, a top end, and a second end.

In another aspect, the bottom portion of the mounting arm may be provided in planar form.

In another aspect, the extendable arm may include a first element and a second element, wherein the second element is insertable and slidable within the first element.

In yet another aspect, an electronic device may be selectively attached to the mounting adapter attached to the extendable arm of the fish finding device mount.

In another aspect, the fish finding device mount may be made out of anti-corrosive material.

In another aspect, the extendable arm is controllably connected to a controller.

In another aspect, the controller may be controllably connected to the extendable arm wirelessly.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a front perspective view illustrating a first embodiment of an electronic device coupled to a retractable fish finding device mount of the present invention;

FIG. 2 presents a front perspective view of the fish finding device mount in an extended position;

FIG. 3 presents a front perspective view of the fish finding device mount coupled to the stern of a boat;

FIG. 4 presents a front side view of the fish finding device mount originally shown in FIG. 1, coupled to the stern of a boat in a retracted position and out of the water;

FIG. 5 presents a front side view of the fish finding device mount coupled to the boat in FIG. 4, in an extended position submerged below the boat's hull;

FIG. 6 presents an enlarged view of the electronic device coupled to the fish finding device mount a distance underneath the boat's hull; and

FIG. 7 presents a front side view of the receiver connected to the electronic device coupled to the fish finding device mount operating without issue while the boat is traveling at a high rate of speed.

Like reference numerals refer to like parts throughout the several views of the drawings.

### DETAILED DESCRIPTION OF THE PREFERRED EMBODIMENT

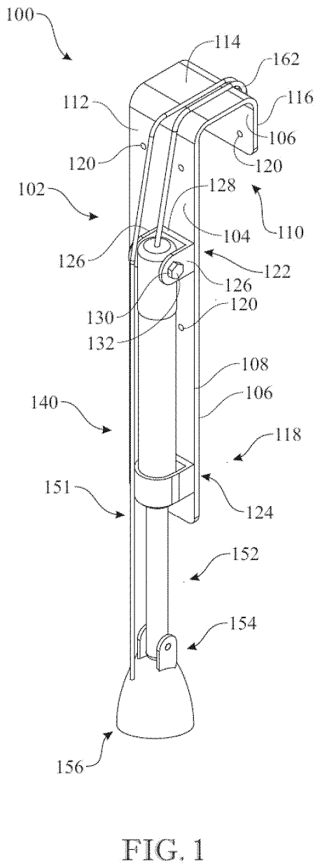

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Referring initially to FIGS. 1-3, an exemplary embodiment of a fish finding device mount 100 is generally shown. The fish finding device mount 100 generally comprises a mounting arm 102 of an unbendable thickness 108 that includes an exterior surface 104 and an interior surface 106. The mounting arm 102 generally provides a top portion 110 and a bottom portion 118 forming a unitary body. The top portion 110 of the mounting arm 102 may include a continuous first end 112, a top end 114, and a second end 116 that form to provide a bent arm. The bent arm provided by the top portion 110 of the mounting arm 102 may be provided in the form of a u-shaped arm. In contrast to the top portion 110 of the mounting arm 102, the bottom portion 118 of the mounting arm 102 is generally provided in planar form, i.e., having a flat configuration. As illustrated in the accompanying figures, the mounting arm 102 may include a plurality of fastener apertures 120 positioned throughout the body of the mounting arm.

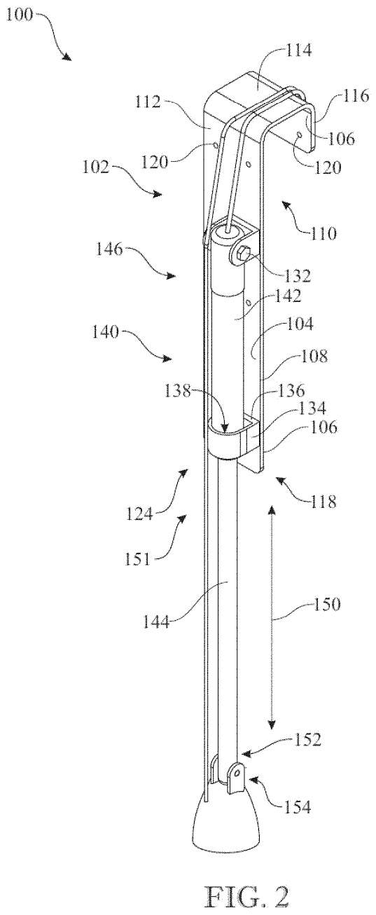

With continued reference to FIG. 1, the fish finding device mount 100 may also include a pair of brackets 122, 124 affixed to the mounting arm's exterior surface 104. Although the accompanying figures illustrate at least two brackets 122, it should be readily understood by one of ordinary skill that at least one bracket, or perhaps in other exemplary instances more than two brackets, may be employed for carrying out the purpose of the present invention. Therefore, the following description of the illustrations regarding the number of brackets used should be appreciated as exemplary and not limiting. The brackets used with the fish finding device mount 100 may include a pair of nonidentical brackets. For instance, the fish finding device mount 100 may include a first bracket 122 affixed about, but just below, the first end 112 of the top portion 110 of the mounting arm 102. The first bracket 122 may be provided in a number of configurations. However, for the purposes of illustration only, the first bracket 122 in this instance is provided in the form of a u-shaped bracket having two opposite members 126 extending outwardly from a planar member 128. The two opposite members 126 may include a fastener receiving hole 130 for receiving a fastener 132, e.g., a through-bolt. The planar member 128 of the first bracket 122 may be selectively attached to the mounting arm 102 by way of fasteners, welded, or other conventional means. With Reference to FIG. 2, the fish finding device mount 100 may include a secondary bracket 124, and may be affixed about the bottom portion 118 of the mounting arm 102. The second bracket, similarly to the first bracket 122, may be provided in a number of configurations. However, as shown, the second bracket 122 is provided in the form of a curved slender member 134 affixed to a planar member 136 that provides a through-hole 138. The planar member 136 of the second bracket 124 may be selectively attached to the mounting arm 102 by way of fasteners, welded, or alternative means.

Referring now to FIGS. 1 and 2, the fish finding device mount also includes an extendable arm 140. The extendable arm may comprise of a first element 142 and a second element 144. The second element 144 may be selectively insertable and slidable within the interior spacing of the first element 142. The proximal end 146 of the first element 142 may be selectively attached to the first bracket 122 that is attached to the mounting arm 102. As illustrated, the proximal end 146 of the first element 142 may be attached to the first bracket 122 by way of a fastener 132, such as a through-bolt. The distal end 148 of the first element 142 is passed through the through-hole 138 provided by the secondary bracket 124 to retain the distal end 148 of the first element 142 thereto. The secondary element 144 of the extendable arm 140 is designed to move about in the upward and downward direction 150, with a portion of the proximal end 151 of the second element moving within the through-hole 138 of the second bracket 124. Opposite the proximal end 151, the distal end 152 of the secondary element 144 of the extendable arm 140 may include a mounting adapter 154 attached thereto. The mounting adapter 154 is configured and otherwise crafted to be selectively attachable to an electrical device 156 that emits sound waves or acoustic energy pulses and then interprets the echo electronic device receives in return to catalog distances of objects.

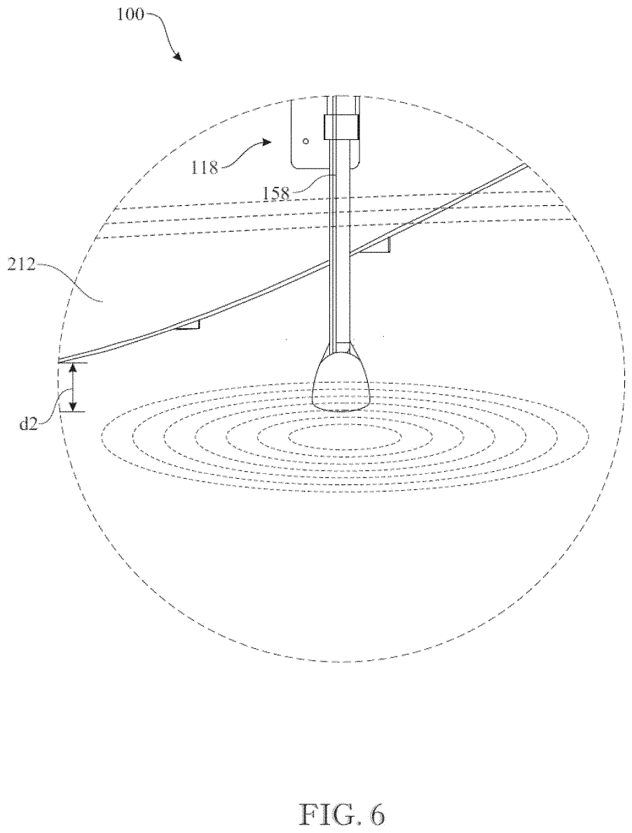

Referring now to FIGS. 1 and 3-7, an illustrative assembly process and operational use of the fish finding device mount 100 is described.

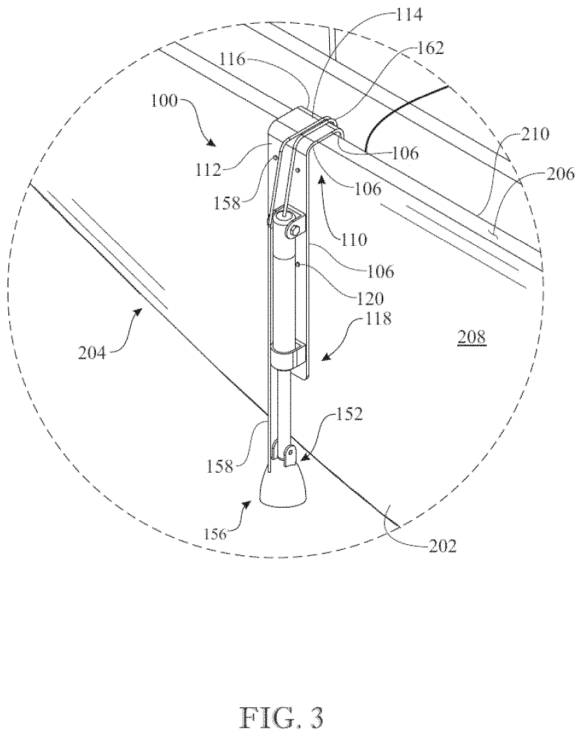

With initial reference to FIG. 3, the assembly process of the fish finding device mount 100 generally comprises attaching the mounting arm 102 to the section of the stern 204 of the boat 200 that connects the port and starboard sections of the boat's hull, also known as the transom 202. More specifically, the top portion 110 of the mounting arm 102 is placed over the upper surface 206 of the boat's transom 202, such that the interior surface 106 of the first end 112 of the top portion 110 of the mounting arm 102 is in contact with the exterior surface 208 of the boat's transom 202. Concurrently, the upper surface 206 of the boat's transom 202 is in contact with the interior surface 106 of the top end 114 of the top portion 110 of the mounting arm 102, and the interior surface 106 of the second end 116 of the top portion 110 of the mounting arm 102 is in contact with an interior surface 210 of the boat's transom 202. After the mounting arm 102 is joined to the transom 202, the mounting arm 102 may be removably affixed to the transom by way of fasteners 158 inserted through the plurality of apertures 120 provided about the length of the mounting arm 102.

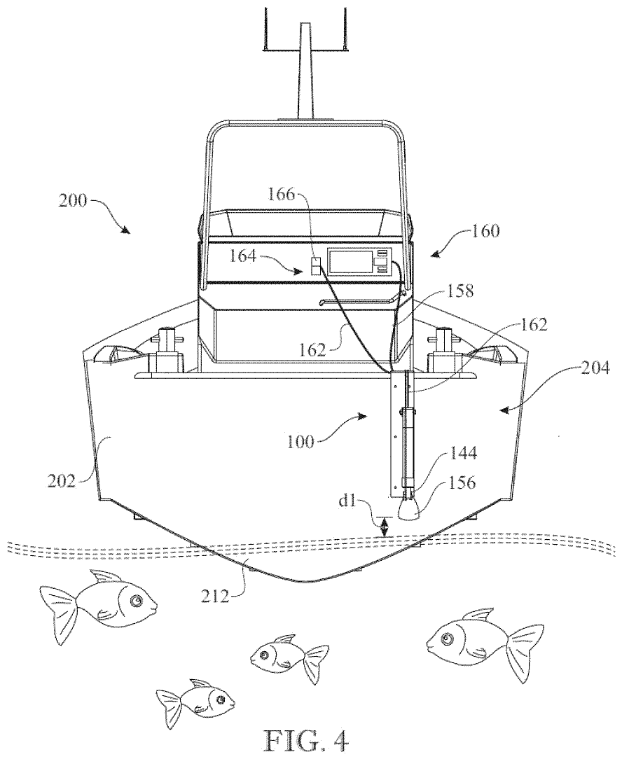

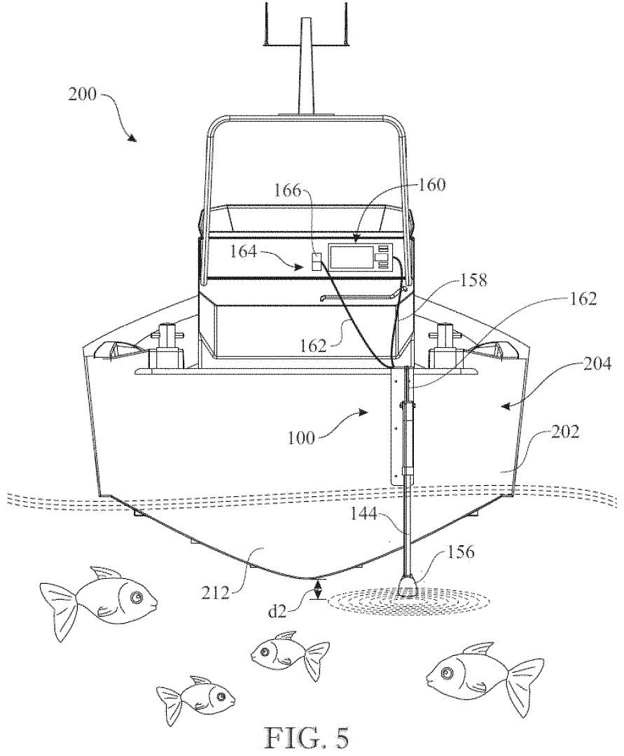

It is generally advised that the first and second bracket 122, 124 of the fish finding device mount 100 be attached to the mounting arm 102 prior to the arm's attachment to the transom 202 of the boat 200; however, the first and second bracket may be attached afterwards without issue. The attachment of the first and second bracket 122, 124 may be accomplished by fastening or welding each bracket to the mounting arm with the first bracket 122 positioned above the second bracket 124, with both brackets in axial alignment. Once the first and second bracket 122, 124 are attached to the mounting arm 102, the proximal portion of the extendable arm 140 is inserted in-between the space provided by the U-shaped bracket, i.e., first bracket 122, with the distal portion of the extendable arm 140 being inserted through the receiving hole 138 of the secondary bracket 122. Once the extendable arm 140 is sitting in the optimal position to be attached, the proximal end 146 of the mounting arm's first element 142 is affixed to the first bracket 124, with the distal end 148 of the first element sitting within the through-hole 138 of the second bracket 124. As is best seen in FIG. 2, the second element 144 is free to move in the upward and downward direction. The mounting adapter 154 for the electrical device 156 used with the fish finding system can then be attached to the distal end 152 of the second element 144 of the extendable arm 140. In one exemplary form, the extendable arm 140 may be controlled by an operator through either mechanical, electrical, or pneumatic means. A control line 162 connected to the first element 142 of the extendable arm 140 may be wired from the extendable arm 140 to a controller 164 that may be installed on the boats console near the receiver 160. The controller 164 may include at least two input buttons 166 that would allow the boat operator to selectively trigger the movement of the extendable arm in the downward and upward direction. For instance, the boat operator may elect to press an input button 166 on the controller 164 that signals the second element 144 of the extendable arm 140 to move in the upward direction and remove the electronic device 156 from the water (FIG. 4). Alternatively, the operator may elect to press an input button 166 on the controller 164 that signals the second element 144 of the extendable arm 140 to move in the downward direction to submerge the electronic device 156 to a desirable depth (FIG. 5). In one exemplary embodiment, the controller 164 may be designed and otherwise configured to control the extendable arm 140 by wireless means. For example, the extendable arm may include a device, such as an electronic servo that is wirelessly connected to the controller 164 by way of Bluetooth, or any other wireless methods provided, to control the upward and downward movement of the extendable arm.

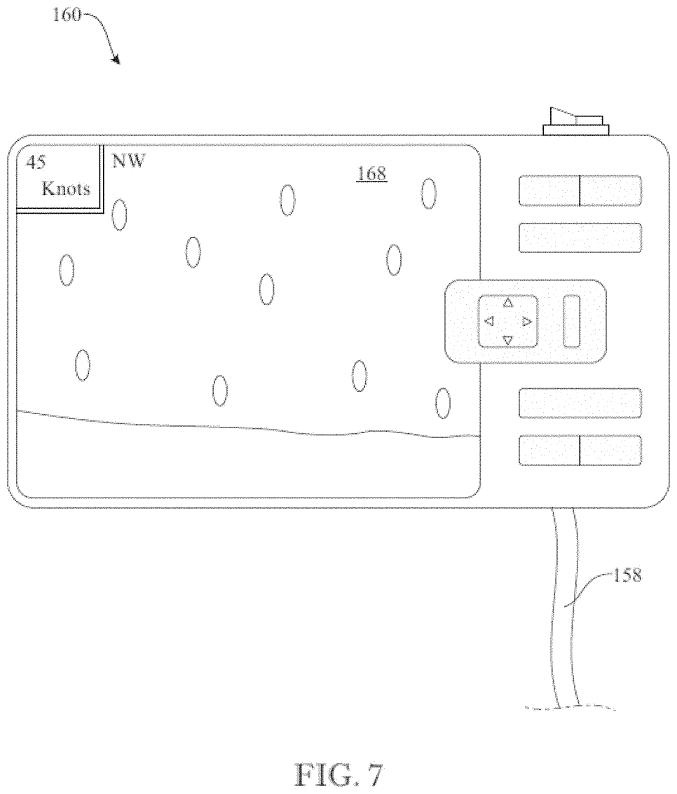

Referring now to FIGS. 3 and 7, once the fish finding device mount 100 has been attached to the transom 204 of the boat 200, the electronic device 156 may be attached to the mounting adapter 154. The electronic device 156 may be electronically connected to a receiver 160. The electronic device may be communicable with the receiver by way of a communication line 158 that's fed to the receiver 160, or through wireless means, i.e., Bluetooth. The receiver 160 is able to analyze and catalog the information being provided by the electronic device 156 and display said information on the receiver's display screen 168.

With reference now to FIGS. 4-6, the fish finding device mount 100 is designed to submerge an electronic device 156, such as a transducer a distance d2 below the boat's hull 212. The distance d2 below the boat's hull 212 is about 8-10 inches, which prevents the boat's hull 212 from causing any form of interference with the electronic device 156 while the boat is either in movement at a high rate of speed, wading through the water, or floating about. Once the operator of the boat 200 decides to no longer use the fish finder device on board, the operator may elect to fully retract the extendable arm 140 retaining the electronic device 156 out of the water. As illustrated in FIG. 4, the electronic device 156 sits a distance d1 above the water line when the extendable arm 140 is fully retracted. This shields the electronic device 156 from being accidentally struck by a foreign object while the boat is either in, out, or being taken out of the water, e.g., boat 200 being loaded on to a trailer bed. It should also be readily understood that all of the elements associated with the fish finding device mount 100 are made out of material that is anti-corrosive and is able to be submerged into fresh as well as salt bodies of water without having adverse effects to the fish finding device mount 100.

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

What is claimed as being new, useful and desired to be protected by Letters Patent of the United States is as follows:

1. A fish finding device mount, comprising:
a) amounting arm;
b) at least one bracket affixed to said mounting arm;
c) an extendable arm securable to said at least one bracket; and
d) a mounting adapter securable to said extendable arm.

2. The fish finding device mount of claim 1 wherein said at least one bracket is comprised of a first bracket and a second bracket.

3. The fish finding device mount of claim 2 wherein said first bracket and a second bracket are not identical.

4. The fish finding device mount of claim 3 wherein said first bracket has a u-shaped configuration.

5. The fish finding device mount of claim 4 wherein said second bracket includes a through hole.

6. The fish finding device mount of claim 1 wherein said mounting arm includes a body of an unbendable thickness, said body having an exterior surface and an interior surface.

7. The fish finding device mount of claim 6 wherein said mounting arm further includes a top portion and a bottom portion to form a unitary body.

8. The fish finding device mount of claim 7 wherein said top portion of said mounting arm is comprised of a bent arm having a continuous first end, a top end, and a second end.

9. The fish finding device mount of claim 8 wherein said bottom portion of said mounting arm has a planar form.

10. The fish finding device mount of claim 1 wherein said extendable arm includes a first element and a second element, said second element being insertable and slidable within said first element.

11. The fish finding device mount of claim 1 further including an electronic device selectively attached to said mounting adapter.

12. The fish finding device mount of claim 1 wherein said further including a controller controllably connected to said extendable arm.

13. The fish finding device mount of claim 12 wherein said controller is connected to said extendable arm wirelessly.

14. The fish finding device mount of claim 5 further including a controller controllably connected to said extendable arm.

15. The fish finding device mount of claim 6 further including a controller controllably connected to said extendable arm.

16. The fish finding device mount of claim 7 further including a controller controllably connected to said extendable arm.

17. The fish finding device mount of claim 8 further including a controller controllably connected to said extendable arm.

18. The fish finding device mount of claim 9 further including a controller controllably connected to said extendable arm.

19. The fish finding device mount of claim 10 further including a controller controllably connected to said extendable arm.

20. The fish finding device mount of claim 11 further including a controller controllably connected to said extendable arm.
